(19) United States
(12) Patent Application Publication
(10) Pub. No.: US 2010/0238231 A1
(43) Pub. Date: Sep. 23, 2010

(54) Inkjet printer having a rolling mechanism for flattening ink droplets

(76) Inventors: Hsien-Chang Lin, Hsi Chih City (TW); Jui-Wen Cheng, Hsi Chih City (TW)

Correspondence Address: Muncy, Geissler, Olds & Lowe, PLLC, 4000 Legato Road, Suite 310, FAIRFAX, VA, 22033, US

(21) Appl. No.: 11/980,773

(22) Filed: Oct. 31, 2007

(51) Int. Cl. B41J 2/015

(52) U.S. Cl. 347/20

(57) ABSTRACT

An inkjet printer having a rolling mechanism for flattening ink droplets is disclosed. The inkjet printer includes a carriage track being connected to a work platform of the inkjet printer, a printing module slidably mounted upon the carriage track to allow lateral movement, and at least one rolling mechanism disposed on the sidewall of a inkjet printhead assembly of the printing module or independently mounted upon the carriage track, wherein the rolling mechanism can roll over the surface of print media and flatten the ink droplets thereon before drying, to form printed image layers with uniform thickness for increasing image quality and reliability of the inkjet printer.

### FIELD OF THE INVENTION

The present invention relates to an inkjet printer having a rolling mechanism for flattening ink droplets, and particularly to the use of a roller for rolling over the surface of print media and flattening the ink droplets thereon before drying, to form printed image layers with uniform thickness for increasing image quality and reliability of the inkjet printer.

### BACKGROUND OF THE INVENTION

Large inkjet printers are well developed and known that the ejected inks under a appropriate curing process would appear highly desirable and afford a tough, durable image upon print media to which they are applied. This makes the large inkjet printers especially applicable to printing on various material with different properties or thickness such as plastics packaging, conventional cellulosic substrates and synthetic polymeric substrates. Thus, large inkjet printers can make images more easily, more quickly and more inexpensively than gravure printing system which the pre-processing thereof takes much cost and times.

In the conventional large inkjet printer, print media to received the printed image rests on a horizontally extending sliding table which is situated below a movable carriage carrying a printing module. The printing module includes a plurality of ink containers and a plurality of ink cartridges in fluid communication with the containers, with each cartridges provided with a bottom nozzle to emit droplets of differently colored ink onto the print media. Thus, the inkjet printing module is controlled by a computer that is programmed to moved along a carriage track across the sliding table and energize nozzles of print heads as the printing module traverses across the print media. The ink droplets on the print media is then cured by curing devices, such as a ultraviolet irradiator device, to provide the desired final image.

It is understood that the ink droplets printed on the print media will determine the image quality, and the key point of print quality is the shape and dimension of the ink droplets formed on the surface of the print media. For example, when the ink droplets are ejected on an impervious substrate, the ink droplets are roughly spherical or elliptical, and the interfacial interaction between the ink and substrate influences ink spreading, which is characterized by a contact angle. In addition, different hydrophilic nature of the substrate gives rise to different contact angles/height of the ink droplets. This results in various shape and height of ink droplets formed on the surface of the print media after drying, and the printed image represents a non-uniform light reflection, especially when various color inks with different characteristics are used in the printing module. However, it is difficult to form a repeatable shape of ink droplet, and images with non-uniform light reflection is difficult to reach a vivid image quality level. Thus, the resulting print quality can be significantly influenced by the configuration of ink droplets ejected onto the surface of the print media, and the printing cost would be increased due to a lower quality level of printed images.

Accordingly, there is a need for an improved large inkjet printer of reduced cost and high throughput to overcome the shortcomings of the prior art.

### SUMMARY OF THE INVENTION

It is an object of the present invention to provide an inkjet printer having a rolling mechanism for flattening ink droplets. The inkjet printer includes a rolling mechanism with a roller for rolling over the surface of print media such that the ink droplets thereon may be flattened before drying. The printed surface of the print media forms an uniform layer to increase the image quality and reduce the waste during printing.

Another object of the present invention is to provide an inkjet printer having a rolling mechanism, wherein the rolling mechanism further includes an adjusting apparatus for adjusting an appropriate pressure from the roller onto the surface of the print media when printing onto various print media with various properties, such as paper, metal, or sponge.

To achieve the above stated objects, the inkjet printer according to the present invention comprises a carriage track being connected to a work platform of the inkjet printer, a printing module comprising a carriage and an inkjet printhead assembly being secured to the carriage. The carriage is slidably mounted upon the carriage track to allow lateral movement of the inkjet printhead assembly for ejecting ink droplets onto the surface of print media, at least one rolling mechanism with a roller positioned on a sidewall of the inkjet printhead assembly of the printing module, one arc surface of the roller makes contact with the surface of the print media for flattening the ink droplets thereon, and at least one ultraviolet irradiator device.

In an embodiment of the present invention, the rolling mechanism further comprises an adjusting apparatus. The adjusting apparatus includes two sliding members, two springs and two adjusting screws, wherein the two end of the shaft of the roller are respectively connected to the sliding members, and each spring is respectively disposed between a sliding member and a adjusting screws to adjusting the pressure from the roller onto the print media.

In an embodiment of the present invention, the ultraviolet irradiator device is connected to the rolling mechanism in an arrangement that the rolling mechanism is disposed between the ultraviolet irradiator device and the printing module, and the ultraviolet irradiator device is configured to cast a beam of ultraviolet light downward to irradiate and dry the flattened ink droplets on the surface of the print media.

In another embodiment of the present invention, the rolling mechanism further includes a driving device being connected to the carriage track, and a roller being secured on the driving device and making contact with the surface of the print media by one arc surface thereof, wherein the roller is driven by the driving device following the moving of the inkjet printhead assembly to flatten the ink droplets.

Other objects, advantages and novel features of this invention will become more apparent from the following detailed description when taken in conjunction with the accompanying drawings.

### BRIEF DESCRIPTION OF THE DRAWINGS

FIG. 1A is a schematic view of a portion of the first embodiment illustrating how the rolling mechanism operates according to the present invention;

FIG. 1B is a schematic view of the first embodiment of the rolling mechanism according to the present invention;

FIG. 2A is a schematic, cross-sectional view of a prior art illustrating the light reflection from the ink droplets ejected on the surface of a print medium;

FIG. 2B is a schematic, cross-sectional view of the present invention illustrating the light reflection from the ink droplets ejected on the surface of print medium after being flattened; and

FIG. 3 is a schematic view of a portion of the second embodiment according to the present invention.

### DETAILED DESCRIPTION OF THE PREFERRED EMBODIMENT

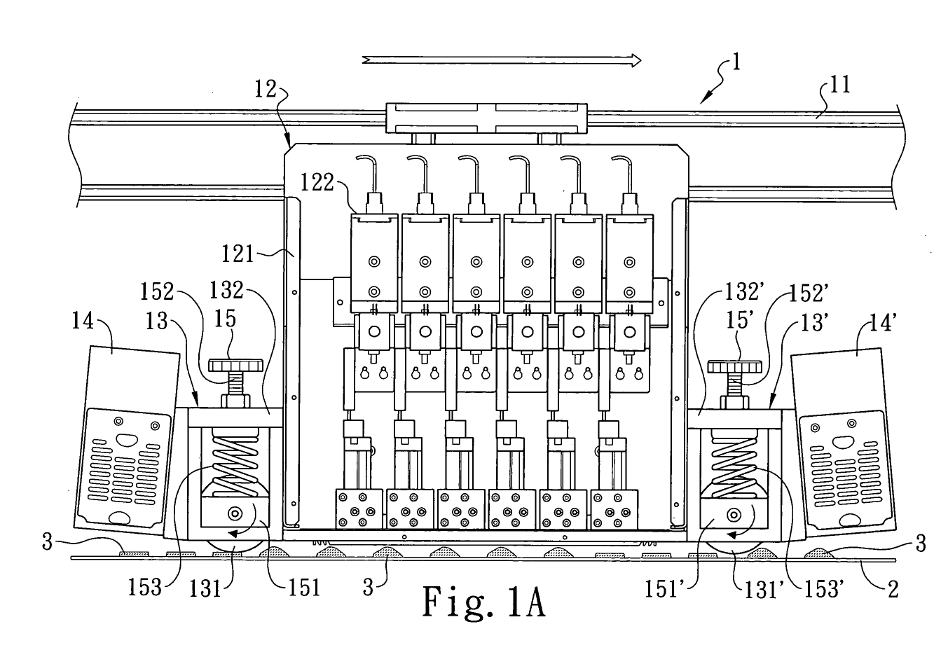

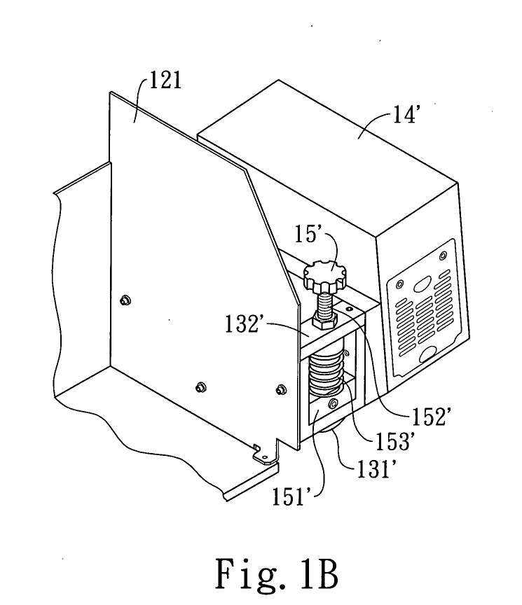

Referring to FIGS. 1A and 1B, there is shown a first embodiment of an inkjet printer constructed in accordance with the present invention having a rolling mechanism for flattening ink droplets. The inkjet printer comprises a carriage track 11, a printing module 12, two rolling mechanisms 13 and 13′, and two ultraviolet irradiator devices 14 and 14′. The carriage track 11 is connected to a work platform (not shown) of the inkjet printer. The printing module 12 includes a carriage 121 and an inkjet printhead assembly 122, wherein the inkjet printhead assembly 122 is secured to the carriage 121, and the carriage 121 is slidably mounted upon the carriage track 11 to allow lateral movement of the inkjet printhead assembly 122 for ejecting ink droplets onto the surface of a print medium 2.

Each rolling mechanism 13 and 13′ respectively includes a roller 131 and 131′ being connected to sidewalls of the inkjet printhead assembly 122 of the printing module 12 by a supporting frame 132 and 132′, wherein one roller 131 is spaced from and positioned substantially parallel to the other roller 131′, and thus the movement of rolling mechanisms 13 and 13′ is transverse to the direction in which print medium 2 is advanced during printing. Preferably, the surface of the roller is formed of non-stick material such as polytetrafluoroethylene (PTFE), and the arc surfaces of roller 131 and 131′ simultaneously roll over the surface of the print medium 2 immediately following the ink ejection during printing for flattening the ink droplets 3 ejected thereon.

Ultraviolet irradiator devices 14 and 14′ are respectively connected to the supporting frames 132 and 132′ of rolling mechanism 13 and 13′ in an arrangement that each rolling mechanism is disposed between a ultraviolet irradiator device and a printing module, and the ultraviolet irradiator devices 14 and 14′ are configured to cast a beam of ultraviolet light downward to irradiate and dry the flattened ink droplets 3 on the surface of the print medium 2.

It is preferred that each rolling mechanism further includes an adjusting apparatus for adjusting the pressure from the roller onto the surface of the print medium 2. In one embodiment, the adjusting apparatus 15 and 15′ includes two sliding members 151 and 151′, two adjusting screws 152 and 152′, and two springs 153 and 153′. Supporting frames 132 and 132′ include grooves (not shown) with integrated sidewalls sized and shaped to correspond with the configuration of two ends of sliding members 15 and 15′. The two end of the shaft of rollers 131 and 131′ are respectively connected to the sliding members 15 and 15′, and each spring 151 and 151′ is respectively disposed between a sliding member and an adjusting screw. Thus, the pressure from rollers 131 and 131′ suitable for the print medium may be adjusted by tightening or loosening the adjusting screws 153 and 153′.

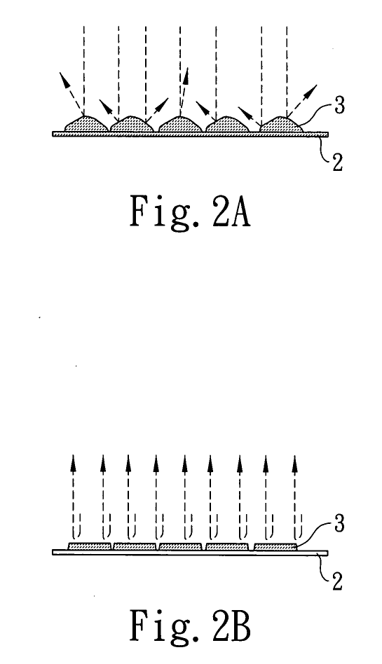

Therefore, rolling mechanism 13 and 13′ can be removed following the printing module 12 upon the carriage track 11, and flatten the ejected ink droplets 3 on the surface of the print medium 2 immediately following the ink ejection during printing. For example, when the printing module 12 moves to the right side along the carriage track 11, the roller 131 and the ultraviolet irradiator devices 14 on the left side of the printing module 12 are simultaneously moved to the right side, and the roller 131 immediately rolls over the ejected ink droplets 3 (as shown in FIG. 2A) on the surface of the print medium 2. Meanwhile, the flattened ink droplets (as shown in FIG. 2B) 3 are cured by the beam of ultraviolet light irradiated from the ultraviolet irradiator devices 14 to form an uniform ink/image layer. It could be realized that the object of the present invention can be attained by merely using one rolling mechanism.

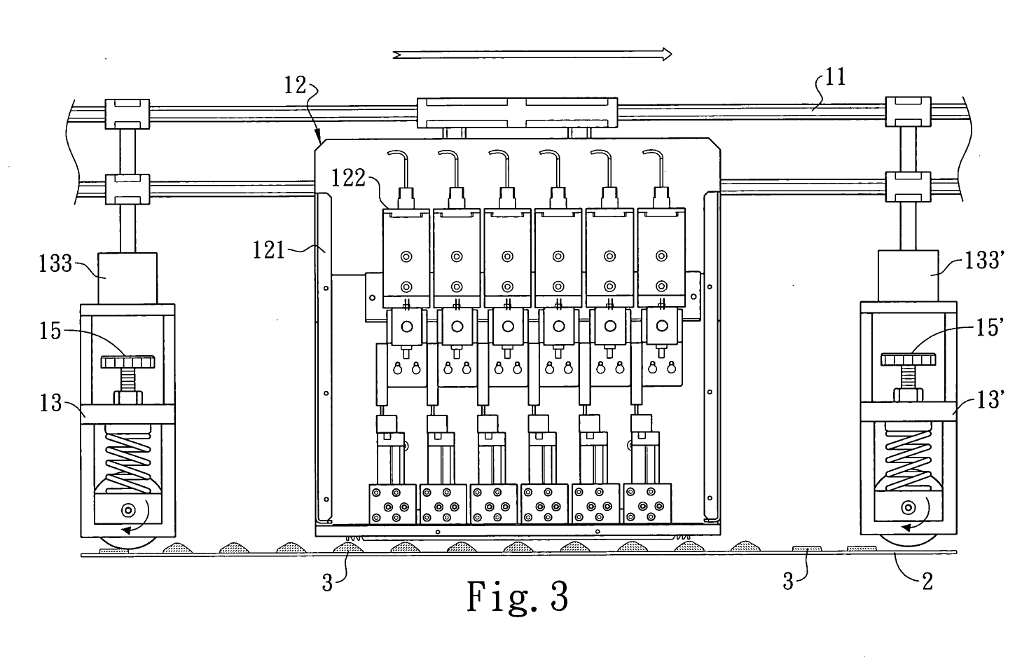

Referring to FIG. 3, in a second embodiment according to the present invention, the inkjet printer comprises a carriage track 11, a printing module 12, and two rolling mechanisms 13 and 13′. The carriage track 11 is connected to a work platform (not shown) of the inkjet printer. The printing module 12 is slidably mounted upon the carriage track 11 by a carnage 121 to allow lateral movement of the inkjet printhead assembly 122 for ejecting ink droplets onto a surface of a print medium 2. The rolling mechanisms 13 and 13′ includes driving devices 133 and 133′, and rollers 131 and 131′. The driving devices 133 and 133′ are connected to the carriage track 11 for moving rolling mechanisms, allowing the rollers 131 and 131′ to make contact with the surface of the print medium by the arc surface thereof. Preferably, the rollers 131 and 131′ are position at a predetermined distance from the inkjet printhead assembly 122 in the direction of movement of the printing module 12, the rollers 131 and 131′ being adjustable so that the predetermined distance may be varied. Thus, the rollers 131 and 131′ can be driven by the driving devices 133 and 133′ following the movement of the printing module 12 to flatten the ink droplets. Preferably, the rolling mechanisms 13 and 13′ are adapted to cause a time lag between printing and flattening.

It is preferred that each rolling mechanism further includes an adjusting apparatus for adjusting the pressure from the roller onto the surface of the print medium, and the structure and operation of the adjusting apparatus is equal to that according to the first embodiment.

Therefore, the present invention has following advantages:
1. By combination of the printing module and the rolling mechanism, the ink droplets on the surface of print media can be flattened immediately following the ink ejection during printing to form an ink layer with uniform thickness and thereby represent a printed image with an uniform light reflection to increase the image quality and reduce the waste during printing.
2. The rolling mechanism has simple structure to be operated singularly under control, and could lower production cost effectively and improve the printing efficiency, quality and reliability on use of the mass production and large-sized print.
3. The pressure from the roller onto the print media can be conveniently adjusted in pursuance of demands or the characteristics of printed material, this can increase the flexibility of use of them.

As stated in the above disclosed, the present invention can surely achieve its expected objects to provide an inkjet printer with a rolling mechanism for flattening the ejected ink droplets on the surface of print media during printing. The construction of the present invention is simple, easy-assembly and could improve the efficiency of large-sized printing.

It should be understood that different modifications and variations could be made from the disclosures of the present invention by the people familiar in the art, which should be deemed without departing the spirit of the present invention.

What is claimed is:

1. An inkjet printer having a rolling mechanism for flattening ink droplets, comprising:
a carriage track being connected to a work platform of the inkjet printer;
a printing module comprising a carriage and an inkjet printhead assembly, wherein the inkjet printhead assembly is secured to the carriage, and the carriage is slidably mounted upon the carriage track to allow lateral movement of the inkjet printhead assembly for ejecting ink droplets onto the surface of print media; and
at least one rolling mechanism for rolling over the surface of the print media following the ejecting of the inkjet printhead assembly.

2. The inkjet printer as claimed in claim 1, wherein the rolling mechanism includes a roller positioned on a sidewall of the inkjet printhead assembly of the printing module, and one arc surface of the roller makes contact with the surface of the print media for flattening the ink droplets thereon.

3. The inkjet printer as claimed in claim 2, wherein the rolling mechanism further includes an adjusting apparatus for adjusting the pressure from the roller onto the surface of the print media.

4. The inkjet printer as claimed in claim 3, wherein the adjusting apparatus further includes two sliding members, two springs, and two adjusting screws, wherein the two end of the shaft of the roller are respectively connected to the sliding members, and each spring is respectively disposed between a sliding member and an adjusting screw.

5. The inkjet printer as claimed in claim 2, further includes at least one ultraviolet irradiator device being connected to the rolling mechanism in an arrangement that the rolling mechanism is disposed between the ultraviolet irradiator device and the printing module, and the ultraviolet irradiator device is configured to cast a beam of ultraviolet light downward to irradiate and dry the flattened ink droplets on the surface of the print media.

6. The inkjet printer as claimed in claim 1, wherein the rolling mechanism further includes a driving device being connected to the carriage track, and a roller being secured on the driving device and making contact with the surface of the print media by one arc surface thereof, wherein the roller is driven by the driving device following the moving of the inkjet printhead assembly to flatten the ink droplets.

7. The inkjet printer as claimed in claim 6, wherein the surface of the roller is formed of non-stick material.

8. The inkjet printer as claimed in claim 7, wherein the surface of the roller is formed of polytetrafluoroethylene (PTFE).

9. The inkjet printer as claimed in claim 2, wherein the surface of the roller is formed of non-stick material.

10. The inkjet printer as claimed in claim 9, wherein the surface of the roller is formed of polytetrafluoroethylene (PTFE).
